(19) United States
(12) Patent Application Publication
(10) Pub. No.: US 2017/0197446 A1
(43) Pub. Date: Jul. 13, 2017

(54) PLANT FOR PRINTING CONTAINERS

(71) Applicant: Till GmbH, Hofheim am Taunus (DE)

(72) Inventor: Heinz Till, Hofheim am Taunus (DE)

(21) Appl. No.: 15/415,284

(22) Filed: Jan. 25, 2017

Related U.S. Application Data
(62) Division of application No. 13/516,494, filed on Jun. 15, 2012, now abandoned.

(30) Foreign Application Priority Data
Dec. 15, 2009 (DE) 10 2009 058 219.3

(51) Int. Cl. B41J 29/17

(52) U.S. Cl. CPC B41J 29/17

(57) ABSTRACT

Described herein is a plant for printing containers, such as bottles, with at least one print image on at least one printing press with at least one printing head, wherein at least two printing presses connected one after the other are designed as carousels for the successive reception of the containers to be printed and the containers are directly transferred from a carousel to a following carousel or received by the latter.

### CROSS-REFERENCE TO RELATED APPLICATIONS

This application is a Divisional of U.S. application Ser. No. 13/516,494, filed Jun. 15, 2012, which is a U.S. National Stage Application under 35 U.S.C. 371 of International Patent Application Serial No. PCT/EP2010/005869, filed Sep. 25, 2010, which claims priority from German Patent Application No. 10 2009 058 219.3, filed Dec. 15, 2009, the disclosures of which are hereby incorporated by reference herein in their entirety.

### FIELD OF THE INVENTION

The invention relates to a plant for printing containers, such as bottles, with at least one print image (type and/or image pattern) on at least one printing press having at least one printing head, and to a method carried out in that way.

### BACKGROUND

It is known that containers such as bottles and other packages can be provided with labels so that consumer information can be attached. It is also known that markings or other information can be applied to the package with continuous inkjet printers, which make possible an individualization, which the label print does not allow. Such printing systems work in monochrome and are restricted to a few printing dots/lines.

Furthermore it is known that printing methods and systems are being worked on, which, by means of printing heads of various manufacturers, allow printing of widths of up to 174 mm per printing head. These printing heads also work in single colour, while with a plurality of colours a plurality of printing heads have to be arranged one after the other and suitably offset so that depending on the number of the colours, always an identical spacing between the individual printing dots is achieved. This is possible with an adjustment on a machine having a plurality of printing heads that are arranged in a fixed manner one after another. The packaging material and the printing heads in the process are relatively passed one another with constant speed. The performance of such a machine is therefore dependent on the printing speed of a respective printing head. Although this is practicable for absorbent packaging materials, the ink, in the case of other materials such as metals, glass or plastic, has to be dried through heat or cured through polymerization by way of UV or electron rays. This operation has to be applied after the printing of each printing colour, which increases the length of such machines. If one wishes to increase the performance, either a plurality of printing systems have to be connected in parallel or another arrangement has to be selected.

It has already been proposed to circularly arrange a plurality of holders for packaging material to be printed on a carousel and to rotate the individual packaging itself on the individual station during the rotation of the carousel and thus guide the surface of the packaging past a plurality of printing heads arranged on each station and aligned relative to one another. Disadvantageous here is that in the case of surfaces, which require the use of UV-curing or electron ray-curing inks, no intermediate drying or polymerization of the individual printing colours is possible.

There is therefore the proposal in addition to apply each colour on individual carousels arranged one after the other, wherein the drying/polymerization can take place on the transfer between the individual carousels. With this embodiment it is provided to clamp the container or the packages in an independent transport unit each to be fastened to the belt in a pitch that is equal to the pitch of the machine and to thus move these one after the other through the different carousels arranged one after the other. This holder would have to be embodied as rotary mounting, so that the containers drive themselves on the carousels and are thus guided past the individual printing head of the respective colour with the entire surface.

It has been proposed, furthermore, to clamp containers in individual holders, wherein each holder rotatably receives the container and has a marking for the 0 degree angle. Clamped-in thus, the containers are individually transported and received in printing presses with the holder connected one after the other. Here, the holder and the receptacle are designed so that a centering of the holder in the machine is effected with such accuracy that the container, matching the print image of the corresponding printing head and through the 0 degree marking is also suitably aligned in the rotary axis. The requirements regarding the centering and the accuracy of the guidance for achieving a high-quality print image in this case however are major and complex, since on start-up and deceleration, different tensile forces act on the belt and temperature fluctuations can additionally occur, both of which result in tolerances being exceeded which cannot be compensated. In addition, it must be taken into account that the container, if it is a bottle, is heavy, as a rule, since the printing normally takes place after the filling. The mass of the holder itself is still added to this weight. The accuracy of the centering requirement becomes clear when it is known that with usual 600 dpi print quality the printing dots are 0.042 mm away from one another and the bottle holder therefore has to be permanently aligned to 1/100 mm. With processing quantities of for example 36,000 bottles/h in the beverage industry, more than 200,000,000 bottles therefore pass through such a machine per year. Wear is consequently great and substantially influences the print quality.

There is additionally the proposal by the applicant in the case of a printing on machines arranged one after the other to align the printing heads by means of electrically driven systems to the bottles individually fed to the machine and the resulting random tolerance of their clamping in a rotary device, in order to thus actively offset the tolerances by means of electric drives.

With all plants discussed up to now, experiences are only available with stationary test systems working under laboratory conditions. However, industrial utilization is to take place with high outputs, e.g. in the case of bottle filling plants with for example 36,000 bottles/h. Here, a bottle and thus also the printing head are transported with a speed of approximately 1.5 m/sec. Because of this, the ink drop is exposed to an airflow that can impair the print quality.

### SUMMARY

The object of the present invention is to propose a plant of the type mentioned at the outset, with the help of which a high printing output can be achieved in a simple manner with reliable operation and high print quality.

With a plant of the type mentioned at the outset, this object is solved for example in that at least two printing presses connected one after the other are designed as carousel for the successive reception of the containers to be printed and the containers are transferred to or received by one carousel directly to following. In this manner, the mechanical effort is substantially reduced since transfer stars are not required.

When, with a plane of the type mentioned at the outset, at least two printing presses connected one after the other are designed as carousels and the carousels have an identical number of stations for the successive reception of the containers to be printed, a tolerance compensation is created, for the same stations always mesh with one another. This outweighs the disadvantage, that a carousel can be smaller if required when a printing ink requires a shorter printing time and its carousel could therefore actually be smaller.

A solution principal according to the invention is to be additionally seen in that for example with a plant of the type mentioned at the outset, wherein the containers during printing are each clamped in a clamping device positioned in a station of the printing press the respective clamping device following the printing of the container in for example the last printing press, leaves the latter, the printed container is separated from the clamping device and the clamping device on a return conveyor end is returned to the entry of for example the first printing press for receiving a new container to be printed.

During the returning to the entry of the for example first printing press, the ink remains can be removed from the clamping devices or dried on the clamping devices for example through UV, EB or heat radiation.

The printing of containers is usually effected with printing inks that are liquid, wherein the printing head is normally supplied with the ink from a cartridge. According to a further aspect of the invention, the respective printing head for example with a plant of the type mentioned at the outset is to be supplied with liquid printing ink, in that a plurality of printing heads or all printing heads of a printing press are supplied with the applicable printing colour from one and the same storage container through transfer pumping of the printing ink. This can be carried out for example through transfer pumping via a central rotary lead-through having an advance channel and a return channel.

Alternatively to this it is proposed to arrange a central tank within the carousel, from which the printing heads are supplied, either each with its own pump or with a central print supply. The central tank can be either replenished or kept at a constant level via a rotary lead-through.

Since only few 100th ml per print are output from the printing head, the pressure constancy of the ink supply is extraordinarily important. Known are static systems, which are not subject to any dynamic acceleration. On a carousel, which processes for example 36,000 containers/h, high centrifugal forces occur by contrast, since the containers and the printing heads are arranged on the carousel circumference. These centrifugal forces are calculated from the angular velocity squared, the radius of the carousel and the mass of the ink. With the stated speed, this amounts up to four times the ink mass in the system. Within the scope of the invention, it is therefore proposed as alternative not to arrange the ink supply as central tank but from individual tanks for one or a plurality of printing heads or as annularly designed tank in each case approximately on the pitch circle of the printing heads, i.e. substantially above or preferably below the printing head or the printing heads. Because of this, there is no mass between the tank and the printing head to be supplied on different radii and the effective centrifugal force is zero. The preferred arrangement of the storage tank or tanks below the printing head or the printing heads has the advantage that no static fluid pressure is present and the individual pumps, which deliver the fluid, can therefore be better controlled.

Since the component of the liquid printing ink within a printing head is likewise exposed to centrifugal forces and the internal pressure on the nozzle outlet can therefore change, it is proposed to configure the supply so that the pressure of the printing head, in particular the pressure at the outlet openings, is constant. This can be effected by means of a controllable pump. Because of the known liquid content in a printing head this control signal can be calculated. However, the control signal can also be provided through feedback from a pressure sensor.

Alternatively it is proposed, instead or in addition to a pump, to utilize a pressure gradient between storage tank and a return tank and only pump back from the return tank into the advance tank and to replenish dispensed printing ink from the rotary lead-through. This allows a high constancy of the pressures, since there is no influence of any pump. The air cushion within the advance tank acts as compensation that does not allow any rapid pressure changes. If required, in the case of inadequate static head, a superimposed pressure can be applied.

Usually, the printing dots are applied next to one another to the container surface by an inkjet printer. According to the invention, the possibility of applying printing dots on top of one another, for example in the case of transparent or opaque material, is to be provided as well.

Within the scope of an economical use of printing plants according to the invention it is additionally proposed to assign a cleaning device to the respective printing head, which can be embodied as suction and/or dabbing device.

Such a cleaning device is arranged either between two successive printing press carousels and/or between an inlet star for the containers to be printed and the printing carousel arranged downstream and/or between a printing carousel and an outlet star arranged downstream, wherein the respective printing head is easily accessible to the cleaning device.

Here, the cleaning device can also be designed as transport star with the same division as the inlet star or the outlet star.

The respective printing head to be cleaned in this case is for example moved into a cleaning position at cleaning intervals and stopped there.

The reliability of a plant according to the invention is additionally supported when on the printed containers print image deviations are for example checked with a camera and the printing head concerned is cleaned in the case of impermissible deviations.

For printing, a liquid printing ink can be advantageously employed, which can be dried and/or polymerized with heat.

When a printing press designed as carousel is operated with different speeds, e.g. for output control, different centrifugal forces are created, as a result of which the printing of the containers with liquid printing ink is negatively influenced. For this reason, it is proposed with a further inventive idea to operate all the carousels with the same circumferential speed matched to the respective throughput performance when printing the containers.

Upon a backing-up of containers after the printing press, the infeed to the printing press of containers to be printed is blocked and the printing operation continued with the same rated output until the last container has left the printing press. Following the rectification of the bottleneck, the printing press is initially regulated to the predetermined rated output and only after this is the infeed of the containers to be printed opened again. Thus, all containers are subjected to an identical treatment, namely both with regards to centrifugal forces as well as processes over time.

A further inventive idea consists in carrying out the printing of the container before its filling in particular in a plant or with a method of the type discussed above.

In this manner it is achieved that the weights transported during the printing and thus the loading of the printing plant are substantially reduced. In addition, when printing the containers, operations can be carried out which could otherwise impair the container content.

In particular, a liquid printing ink that can be dried and/or polymerized with heat can be used with the printing according to the invention.

For drying or polymerization of the ink by means of heat, a flame, a plasma or IR-rays can be employed for example.

Depending on the condition of the container wall, the printing dots can be applied by the inkjet printer multiple times, for colour coverage on top of one another to the container surface, instead of next to one another, which for example is an advantage in the case of transparent or opaque container wall material.

In one embodiment, the invention provides a plant for printing containers, such as bottles, with at least one print image on at least one printing press with at least one printing head, wherein at least two printing presses connected one after the other are designed as carousels for the successive reception of the containers to be printed and the containers are directly transferred to a following carousel or received by such.

In one embodiment, at least two printing presses connected one after the other are designed as carousels and the carousels have an identical number of stations for the successive reception of the containers to be printed.

In one embodiment, the containers during printing are each clamped in a clamping device positioned in a station of the printing press, wherein the respective clamping device after the printing of the container in the for example last printing press, leaves the latter, the printed container is separated from the clamping device and the clamping device on a return conveying end is returned to the inlet of the for example first printing press for receiving a new container to be printed.

In another embodiment, during the returning to the inlet of the for example first printing press the ink remains are removed from the clamping devices or dried on the clamping devices, e.g. through UV, EB or heat radiation.

In another embodiment, the respective printing head is supplied with liquid printing ink, in that a plurality of printing heads or all printing heads of a printing press are supplied from one and the same storage tank with the respective printing ink through transfer pumping of the printing ink.

In another embodiment, the at least one printing press is designed as carousel for the successive reception of the containers to be printed and liquid printing ink from a storage tank for the respective printing ink is fed to the respective printing head or conducted away from the latter through transfer pumping via a rotary lead-through with an advance channel and a return channel.

In one embodiment, the storage tank for the respective printing ink is arranged centrally within the carousel.

In one embodiment, each printing head is assigned its own pump or all printing heads a central pressure supply.

In one embodiment, the printing ink in the storage tank for the printing ink concerned is held at constant level.

In one embodiment, the storage tank for the printing ink concerned for supplying one or a plurality of printing heads is arranged on the pitch circle on which the printing head or the printing heads is or are located.

In one embodiment, the storage tank is substantially arranged directly above or below the associated printing head.

In one embodiment, the storage tank is designed as annular tank.

In one embodiment, the respective printing head is supplied with liquid printing ink and the pressure in the interior of the printing head and in particular at its outlet openings is kept constant.

In one embodiment, the supply of the respective printing head with liquid printing ink is effected by means of a pump that is controllable via a pressure sensor if required.

In one embodiment, a pressure gradient to a return tank is utilized for supplying the respective printing head with liquid printing ink from a storage tank for the respective printing ink.

In one embodiment, the liquid printing ink is pumped back from the return tank into the storage tank.

In one embodiment, the printing head is designed as inkjet printer, characterized in that the inkjet printer applies the printing dots next to one another and/or on top of one another.

In another embodiment, at least one cleaning device designed for example as suction and/or dabbing device that can be assigned to the respective printing head.

In one embodiment, the cleaning device is arranged either between two successive printing press carousels and/or between an inlet star for the containers to be printed and the printing press carousel connected downstream and/or between a printing press carousel and a outlet star arranged downstream.

In one embodiment, the cleaning device is designed as transport star with the same division as the inlet star or the outlet star.

In one embodiment, the respective printing head to be cleaned in each case is moved into a cleaning position at cleaning intervals where it is stopped.

In one embodiment, print image deviations are checked on the containers to be printed for example with a camera and the respective printing head is cleaned in the case of impermissible deviations.

In another embodiment, the invention provides a method for printing containers, such as bottles, with at least one print image on at least one printing press with at least one printing head, wherein a liquid printing ink is employed for printing which can be dried and/or polymerized with heat.

In another embodiment, heat, for example a flame, a plasma or IR-rays are employed for drying or polymerization of the printing ink.

In another embodiment, the carousels during the printing of the containers are all operated with the same circumferential speed matched to the respective throughput performance.

In one embodiment, with a backlog of containers after the printing press the infeed of containers to be printed to the printing press is blocked and the printing press and printing press operation is continued with the predetermined same rated output until the last container has left the printing press.

In another embodiment, following the rectification of the backlog the printing press is initially adjusted to the predetermined rated output and only after this the infeed of the containers to be printed is opened again.

In another embodiment, the printing of the container is effected prior to its filling. In one embodiment, a liquid printing ink is employed for printing which can be dried and/or polymerized with heat.

In one embodiment, heat such as a flame, a plasma or IR-rays are employed for drying or polymerization of the printing ink.

In one embodiment, the printing head is designed as inkjet printer, characterized in that the printing dots are applied on the container surface by the inkjet printer next to one another and/or, if applicable, also multiply on top of one another.

### BRIEF DESCRIPTION OF THE FIGURES

Further objectives, features, advantages and possible applications are obtained from the following description of exemplary embodiments by means of the drawings. Here, all features described and/or represented through image form the subject of the invention by themselves or in any combination, even regardless of their combination in individual claims or their reference.

FIG. 1 is a schematic top view of a plant for printing containers according to the invention,

FIG. 2 is a schematic of the arrangement of a central tank for liquid printing ink for supplying different printing heads of a plant, e.g. according to FIG. 1,

FIG. 3 is a schematic of a sectional representation of the assignment of an external tank for liquid printing ink and central rotary lead-through,

FIG. 4 is a schematic of an operating diagram for the arrangement of an inner tank for liquid printing ink with a printing ink feed via rotary lead-through and feed to the individual printing heads,

FIG. 5 is a representation corresponding to FIG. 4 with arrangement of a storage tank designed as annular tank for liquid printing ink below the printing heads of a printing carousel,

FIG. 6 is a schematic representation of a printing head with pump for the feeding of liquid printing ink with maintenance of a constant pressure at the printing head outlet openings,

FIG. 7 shows another type of printing ink feed with a printing plant according to the invention, and

FIGS. 8a to 8c show different possibilities of assignments of cleaning devices for the printing heads.

### DETAILED DESCRIPTION

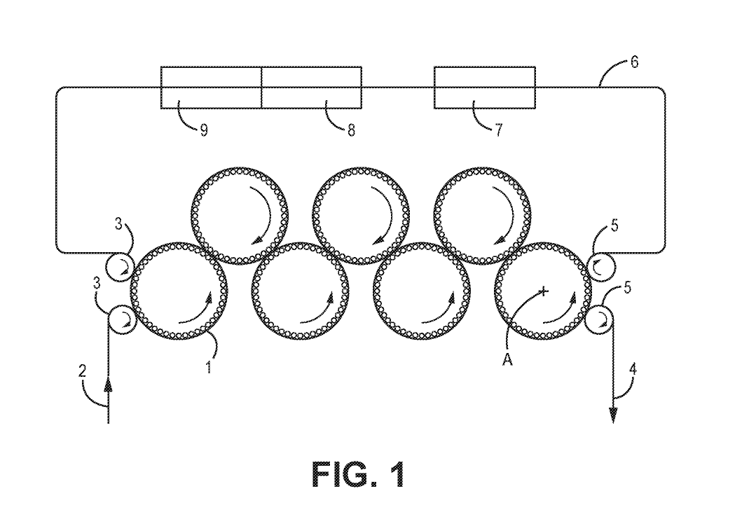

The plant for printing containers shown in FIG. 1 comprises a plurality of printing presses 1 connected one after the other and designed as carousels for the successive reception of containers to be printed, which are transferred to or received by a carousel directly to a subsequent carousel. The containers to be printed are for example transferred via a transport device 2 and an inlet star 3 to a first carousel 1 and subsequently passed on directly to further carousels, wherein in each carousel a printing colour each and/or a printing pattern is applied to the surface of the respective container.

In the carousels, the containers are each received in a clamping device. On the outlet side of the last carousel, the printed containers are each separated from the clamping devices and the former supplied for further use via a transport device 4. The clamping devices freed of the printed containers are led out of the last carousel via a further outlet star 5 and, if applicable cleaned and dried with a drying/retreatment plant 9, returned to the inlet of the first carousel 1 via a return conveying end 6 through an ink drying and/or washing plant 7, 8 if applicable. There, the clamping devices are transferred to the first carousel via an inlet star 3, where they are each available for receiving a new container to be printed, which is fed in via the transport device 2. In this manner, transfer stars between the individual carousels become dispensable in a compact plant and clamping devices for the containers to be printed constantly reusable.

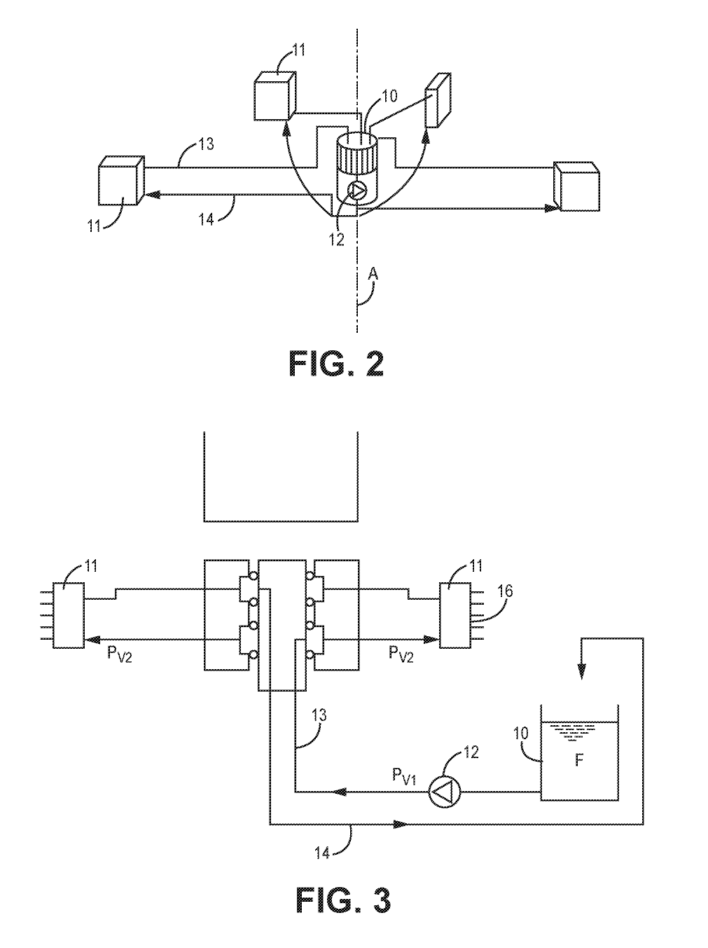

FIG. 2 schematically illustrates a plant for printing containers with printing press 1 designed as carousel. A central storage tank 10 for receiving liquid printing ink is assigned to the printing heads 11 instead of previously known cartridges assigned to each individual printing head. The printing ink F is fed to the printing heads 11 from the storage tank 10 via a pump 12 and excess printing ink F from the printing heads 11 is returned into the storage tank 10. The storage tank 10 can be replenished when it is empty, but also be replaced in a simple manner.

FIG. 3 illustrates a printing press, wherein liquid printing ink F is received in an external storage tank 10 and fed to the individual printing heads 11 with the help of pumps 12 via a central rotary lead-through 15 by means of advance channels 13, which printing heads are arranged in the carousel of a printing press 1. The return of printing ink F is effected via return channels 14.

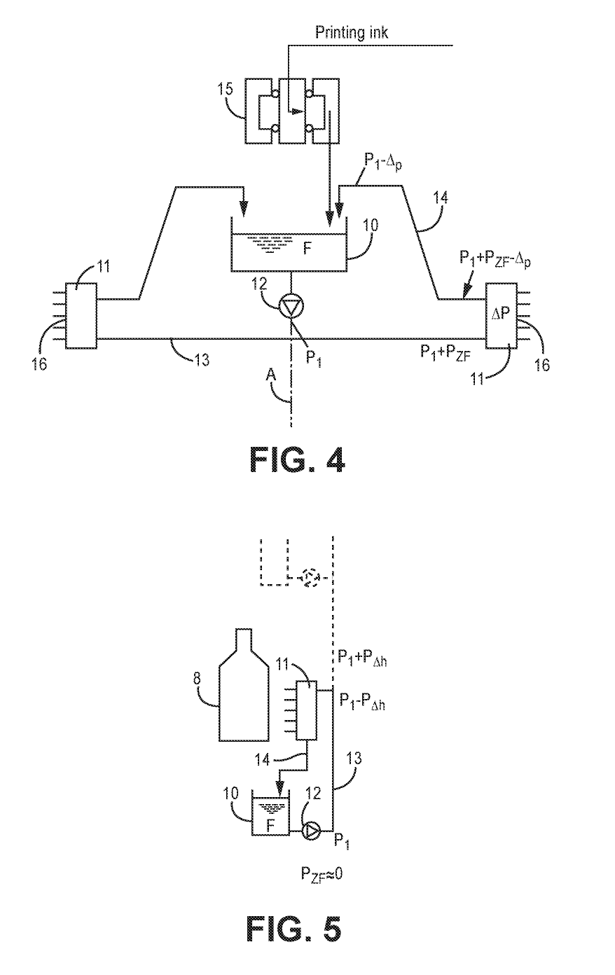

FIG. 4 relates to a plant for printing containers, wherein the printing heads 11 are received in the carousel of a printing press 1 and supplied with liquid printing ink F from an internal storage tank 10. The level of the printing ink F in the storage tank 10 is kept constant through feeding printing ink via a central rotary lead-through 15.

With the printing press arrangement according to FIG. 5, the storage tank 10 for printing ink F is located directly under the associated printing head 11 in the printing press 1 designed as carousel, i.e. on the pitch circle of the printing heads 11. Because of this, no mass is located between printing ink supply and printing head on different radii and the resultant centrifugal force is zero. The arrangement of the storage tank 10 below the printing heads 11 has the advantage that there is no static fluid pressure and the pump 12 can be controlled more easily for feeding the printing ink F to the printing heads 11. The storage tank 10 can be designed as individual tank below the respective printing head 11, but also as annular tank common to all printing heads 11.

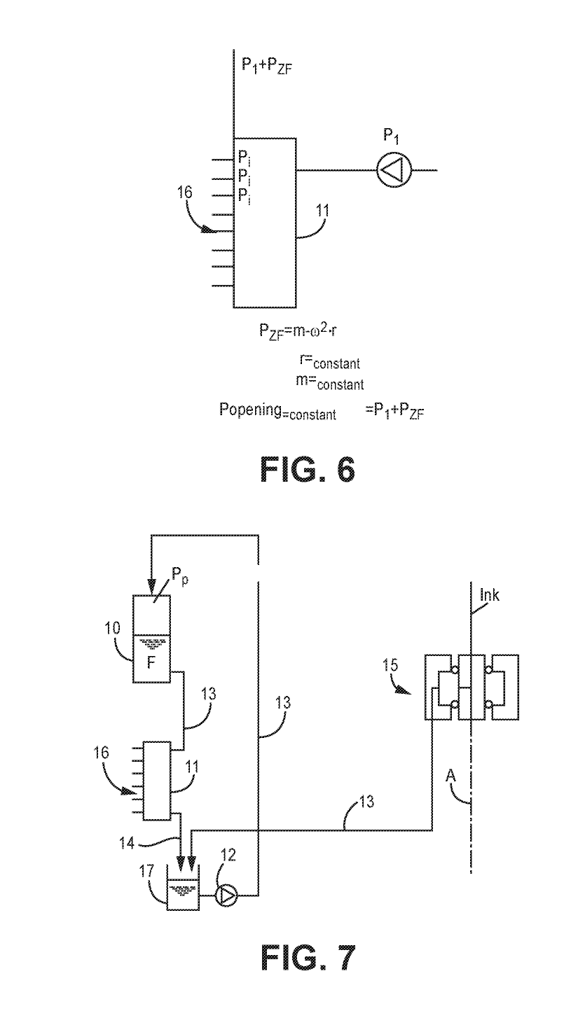

FIG. 6 schematically illustrates how the outlet openings 16 of a printing head 11 can be fed with printing ink F with constant pressure in that the pump pressure P1 is controlled as a function of the rotational speed.

With the plant for printing containers according to FIG. 7, a storage tank 10 and a return tank 17 are provided for the liquid printing ink F above the respective printing head 11 and below the respective printing head 11 respectively. The printing ink F for example fed into the return tank 17 via a rotary lead-through 15 is initially pumped into the storage tank 10 above the respective printing head 11 via a pump 12 initially by way of an advance channel 13, from where a pressure gradient between storage tank 10 and printing head 11 is utilized for the printing ink supply of the printing heads 11. This allows a high constancy of the pressures, since a pump vibration does not have any effect on the pressure at the outlet openings 16 of the printing head 11. The air cushion within the storage tank 10 acts as balance, since it does not allow any rapid pressure changes. If required, a superimposed pressure can be applied if the static head is inadequate.

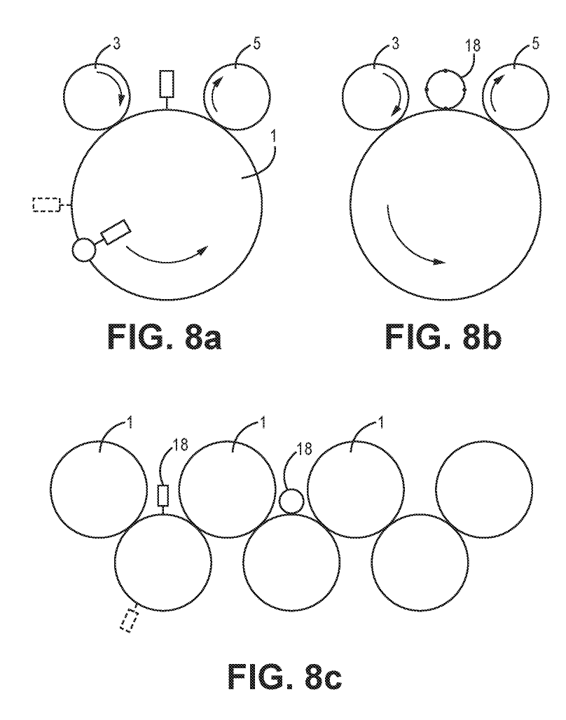

FIGS. 8a to 8c illustrate different possibilities as to how a cleaning device can be assigned to the printing heads relative to the printing presses 1 designed as carousel of a plant for printing containers. With the version according to FIG. 8a, a static cleaning device 18 can be moved into a cleaning position at cleaning intervals, in which a printing head 11 has been brought to a stop on the carousel of the printing press 1. The cleaning device 18 in this is located between the inlet star 3 and the outlet star 5 of the carousel, so that neither containers to be printed nor printed containers impair the cleaning operation. The cleaning of the printing heads 11 in this case takes place discontinuously. With the version according to FIG. 8b, the cleaning device 18 is designed as transport star with the same division as the inlet star 3 and the outlet star 5. Because of this, cleaning can take place continuously during cleaning or after the end of production. With the version according to FIG. 8c, a combination of cleaning devices 18 is indicated, which on the one hand operates with a stationary cleaning device discontinuously or continuously with a cleaning device designed as transport star, wherein the carousels of printing presses 1 connected one after the other transfer or accept the containers to be printed directly without intermediate connection of a transport star to/by the following carousel. In this case, the cleaning devices 18 are located in the neighbourhood of a carousel in each case in the intermediate space between the preceding carousel and the following carousel.

Because of this, the cleaning process can be controlled in that the respective containers to be printed are checked for example with a camera with respect to print image deviations and the printing head concerned, is cleaned in the case of impermissible deviation.

1. A plant for printing containers, with at least one print image on at least one printing press with at least one printing head, wherein the at least one printing press is designed as a carousel for successive reception of the containers to be printed, and wherein at least one cleaning device is assigned to the printing head.

2. The plant according to claim 1, wherein the cleaning device is arranged either between two successive printing press carousels and/or between an inlet star for the containers to be printed and the printing press carousel connected downstream and/or between a printing press carousel and an outlet star arranged downstream.

3. The plant according to claim 2, wherein the cleaning device is designed as transport star with a same division as the inlet star or the outlet star.

4. The plant according to claim 1, wherein the printing head to be cleaned is moved into a cleaning position at cleaning intervals.

5. The plant according to claim 1, wherein print image deviations are checked on the containers with a camera and the printing head is cleaned if impermissible deviations are detected.
